(19) United States
(12) Patent Application Publication
(10) Pub. No.: US 2025/0256998 A1
(43) Pub. Date: Aug. 14, 2025

(54) THE CONTROL OF CONTINUOUS WATER TREATMENT

(71) Applicant: THE WATER & CARBON GROUP PTY. LTD., Brisbane (AU)

(72) Inventors: James Patrick HUNTER, Brisbane (AU); Mark MULLET, Brisbane (AU); Jeffrey TRAVIS, Brisbane (AU)

(21) Appl. No.: 19/054,835

(22) Filed: Feb. 15, 2025

Related U.S. Application Data
(63) Continuation of application No. PCT/AU2024/050938, filed on Aug. 31, 2024.

(30) Foreign Application Priority Data
Aug. 31, 2023 (AU) 2023902809

(51) Int. Cl. C02F 9/00; C02F 1/14; C02F 1/24; C02F 1/52; C02F 1/56

(52) U.S. Cl. CPC C02F 9/00; C02F 1/14; C02F 1/24; C02F 1/5272; C02F 1/56; C02F 2301/08

(57) ABSTRACT

There is provided a continuous stagewise flotation process comprising more than one stage of flotation with independent hydraulic control. The process comprises a first vessel for flotation configured to receive incoming liquid for treatment. The first vessel is associated with a first feed pump for hydraulically controlling the incoming liquid into the first vessel; and a first discharge pump for hydraulically controlling the discharge of first treated liquid from the first vessel. There is also a second vessel for flotation configured to receive incoming first treated liquid from the first discharge pump. The second vessel is associated with a second discharge pump for hydraulically controlling the discharge of second treated liquid from the second vessel.

This application is a bypass continuation of International Application No. PCT/AU2024/050938 filed Aug. 31, 2024 entitled “THE CONTROL OF CONTINOUS WATER TREATMENT,” which claims the benefit of and priority to Australian Patent Application No. AU2023902809 filed Aug. 31, 2023, the contents of both of which being incorporated by reference in their entirety herein.

### TECHNICAL FIELD

The present disclosure relates to water treatment technology focused on removing specific contaminants from polluted water. In an embodiment, the specific contaminants are Per- and polyfluoroalkyl substances (PFAS).

### BACKGROUND

Per- and polyfluoroalkyl substances (PFAS) are a group of man-made chemicals that are persistent in the environment and in the human body. There is evidence that exposure to PFAS can lead to adverse human health effects. Specific PFAS chemicals that have in the past been incorporated into fire-fighting foams have been used on fires at many thousands of emergency and training sites (e.g. airports, air force bases and other military sites, and metro and country fire service training sites). PFAS is also present in many products that find their way to landfill which can mix with rainwater and ultimately leach into ground water. PFAS that has seeped into soil and groundwater and into wastewater, such as landfill, leachate and sewage, has created contaminated sites and contaminated wastewater.

There is a need for improved means to remediate wastewater contaminated with contaminants such as PFAS.

### BRIEF SUMMARY

The present disclosure provides a continuous stagewise flotation process comprising more than one stage of flotation where, despite being continuous, there is independent hydraulic control over each stage of the flotation process. The independent hydraulic control is over each vessel in the process.

In a first aspect there is provided continuous stagewise flotation process comprising more than one stage of flotation with independent hydraulic control, the process comprising:
a. a first vessel for flotation configured to receive incoming liquid for treatment, the first vessel generating a first treated liquid and a first foam;
wherein the first vessel is associated with a first feed pump for hydraulically controlling the incoming liquid into the first vessel; and a first discharge pump for hydraulically controlling the discharge of first treated liquid from the first vessel; and the first foam is collected in a foam tank;
b. a second vessel for flotation configured to receive incoming first treated liquid from the first discharge pump, the second vessel generating a second treated liquid and a second foam,
wherein the second vessel is associated with a second discharge pump for hydraulically controlling the discharge of second treated liquid from the second vessel; and the second foam is collected in the foam tank.

In an embodiment the first foam is collected in a first foam tank. In an embodiment, the second foam is collected in a second foam tank.

Optionally, the process further comprises a third vessel for flotation configured to receive incoming second treated liquid from the second discharge pump, the third vessel generating a third treated liquid and a third foam, wherein the third vessel is associated with a discharge means which can be a valve for controlling the discharge of third treated liquid from the third vessel; and the third foam is collected in the foam tank. The third treated liquid can be collected in a treated leachate storage tank. The third foam can be collected in the second foam tank.

In a second aspect there is provided a continuous stagewise flotation process comprising more than one stage of flotation with independent hydraulic control, the process comprising:
a. a first vessel for flotation configured to receive incoming liquid for treatment, the first vessel generating a first treated liquid and a first foam,
wherein the first treated liquid is collected in a first break tank; and the first foam is collected in a foam tank;
b. a second vessel for flotation configured to receive incoming first treated liquid from the first break tank for treatment, the second vessel generating a second treated liquid and a second foam,
wherein the second treated liquid is collected in a second break tank; and the second foam is collected in the foam tank.

In an embodiment the first foam is collected in a first foam tank. In an embodiment, the second foam is collected in a second foam tank.

Optionally, the process according to the second aspect of the disclosure further comprises a third vessel for flotation configured to receive incoming second treated liquid from the second break tank for treatment, the third vessel generating a third treated liquid and a third foam. The third vessel can be associated with a third pump; and the foam can be collected in the second foam tank.

In the second aspect of the present disclosure, there is provided one or more break tanks between each stage of the flotation process. Each break tank receives treated liquid from the vessel of the preceding stage. The first break tank receives first treated liquid from the one or more first vessels. The second break tank receives second treated liquid from the one or more second vessels. Each break tank means that the treated liquid leaving a vessel is not immediately delivered directly into the next vessel in the series.

The break tanks provide a break in the process. The process can be operated continuously, but there is a break in the process. The break in the process allows for the parameters of each of the vessels to be independently controlled. By “independent control” it is meant that the parameters of the vessel such as gas injection rate, liquid retention time, foam height, liquid height, temperature, pressure, foam formation rate (and other) can be controlled in a given vessel independently of any other vessel in the series.

The selection, control and or adjustment of the foaming process means that each vessel can be independent in an otherwise continuous process. In prior arrangements in which there is no break tank provided this independent control is presently not available. An advantage of independent control is that the system can be optimised which, in embodiments, reduces energy inputs and can improve output quality, foam quality and foam production rates.

In embodiments, due to the break tanks, the system allows for any learnings made in relation to the flotation in the first vessel to be applied to the flotation methodology applied to the second vessel and if applicable to any third vessel in the series.

The following describes an exemplary use of the present process comprising break tanks. Incoming liquid for treatment can be pumped to the first vessel. The hydraulic retention time in the first vessel can be set to, for example, 1 hour and the air:liquid ratio can be set to, for example, 10. The air to liquid ratio is the volume of air added as a ratio of the volumetric flow rate of inlet fluid. The first vessel feed pump can be set to ensure the flow rate allows for a 30-minute retention time in the first vessel. The second vessel feed pump can also be set to the same flow rate to balance the feed rate to the second vessel to allow for a 30-minute retention time in the second vessel.

During operation, the operator monitors the first and second vessels. The operator can notice that there is a feature of the incoming liquid for treatment that effects the operational parameters. For example, the operator can notice that there is excessive foam coming from the top of the first vessel because of an inherent high load of natural surfactants present in the incoming liquid. Upon noticing the excessive foaming, the operator can gradually, over time, adjust the hydraulic height of the water in first vessel until the foam production is reduced to a predetermined rate. The adjustment can be done by dropping the hydraulic height of the water in first vessel using the valve on the hydraulic leg/standpipe discharging the treated water from the first vessel, allowing less and dryer foam to be produced. The drop in hydraulic height should reduce the actual volume of the contaminated water in first vessel. As a result, the flow rate setting for the second vessel feed pump will require adjusting to balance flows. This adjustment can be made independently.

In an embodiment, the break tank allows for these adjustments to be made in relation to the first vessel independently. There is no subsequent unintended disruption to the operation of the second vessel or, in turn the third vessel if present.

In another embodiment, the operator of the plant might notice that there is insufficient foam production from the top of first vessel because of an inherent low load of natural surfactants present. Under these circumstances, the operator can gradually, over time, adjust the air:liquid ratio in the first vessel until this foam production is increased. This adjustment can be done by increasing the air rate pumped into the water in first vessel. The air rate can be increased using the blower Variable Speed Drive (VSD). The increase in air rate will cause a volume increase in the first vessel and a surge of contaminated water to leave the first vessel and enter the break tank. The increased air rate causes a flow surge because the extra air takes up more volume in the vessel which forces liquid out the decant leg/standpipe. The break tank is configured to absorb this surge so the operation of second vessel is substantially unaffected by it. Instead, the second vessel can take a controlled intake of the liquid treated by the first vessel. The operator can now make adjustments to parameters of the second vessel to produce the target foam production rate from the second vessel. The second break tank arranged between the second and a third vessel if present can absorb the flow changes from second vessel while the adjustments are being made to the operation of the third vessel. Similar adjustments to obtain the optimum operating conditions for the third vessel can be made.

In the first aspect of the disclosure, there are no break tanks between the vessels. Each vessel is hydraulically connected to the next vessel in the series. Each vessel is associated with a pump which can control the hydraulic height within the vessel. By “independent hydraulic control” it is meant that the control of the hydraulics of each vessel is independent of each of the other vessels in the process.

In prior arrangements, a single feed pump was used for multiple vessels in series. These prior vessels were directly connected hydraulically and gravitationally fed without break tanks. In the first aspect of the disclosure, each vessel in the series has its own control systems. The first vessel can have a first vessel discharge pump. The second vessel will receive water from the first vessel discharge pump and will have a second vessel discharge pump, and so on.

In an embodiment of the present disclosure, where break tanks are excluded, the operator sets the flow rate through the entire system by the pump (first feed pump) feeding the first vessel. The liquid height in the first vessel is controlled by adjusting the first vessel discharge pump speed using a variable speed drive (VSD). The pump speeds up to lower the level in the vessel, and slows down to increase the level in the vessel. The control logic will maintain the vessel water level at a level requested by the operator. This first vessel discharge pump then moves the water on to the second vessel. In an embodiment, the water level in each vessel can be monitored by a sensor.

The adjustment of the liquid height in the first vessel may also make use of an overflow pipe or standpipe, which is an open topped pipe in fluid communication with the vessel. The standpipe allows for an unagitated volume of water to accurately measure the liquid height in the vessel and assist in the control of the rate of liquid transfer by the pump.

In all aspects of the disclosure, each vessel can have its own blower. The first vessel can have a first blower. The second vessel can have a second blower, and so on. Each blower can be controlled by a variable frequency drive that allows the operator to select the blower discharge capacity to deliver to each vessel.

The following description applies to each of the first and second aspects of the disclosure unless the context makes clear otherwise.

The flotation is a foam or froth flotation. The foam or froth flotation can be undertaken in a flotation cell. The flotation cell can be referred to as a foam fractionator. The foam fractionator can be a column. In the description herein, sometimes each cell, fractionator or column is referred to as a vessel.

The flotation process described herein may comprise:
(1) A means for injecting air bubbles into a sample of contaminated water in the fractionator vessel. This requires an air pump and pipe, with a specially modified element at the exit that create air bubbles of a specific size and size distribution. Typically, this element is an air diffuser—a fine pore membrane or filter element, typically with pores >2 microns and up to 100 microns, made from ceramic, polymeric of metallic materials.
(2) After the bubbles have risen through the water, attracting PFAS molecules, and formed foam at the surface, there is a means to remove and capture the foam. This can be via an air blower, a vacuum suction system, a physical scraping arm, gravity, laundering or a collection hood or other means. The foam is captured in a separate tank. During these processes the foam can “break” creating a reduced volume “foamate” solution.
(3) Additional means to “break” the foam in order to reduce the volume and form a “foamate” includes happening naturally by storage and settling, or it can be achieved by chemical or mechanical means.
(4) Further reduction of foam volume can be achieved by drying of the foam to remove water. Drying can be achieved by solar evaporation or by one of many means of thermal evaporation with added energy (e.g. IR drying, convective drying, and others).

The present flotation process comprises more than one stage of flotation. The flotation processes herein described is therefore stagewise. It involves the use of one or more first vessels and one or more second vessels, or flotation cells, arranged in a sequence or series, with each stage designed to enhance the previous stage resulting in cleaner treated liquid with more of the PFAS removed after each subsequent stage.

The flotation processes herein described is continuous. It involves the leachate from one vessel flowing, optionally via a break tank, to a second vessel for further treatment. The process described herein is not a batch process.

The incoming liquid into the first vessel, and subsequent vessels, is under continuous flow. This flow is not stopped or paused during the treatment. A batch process, on the other hand, requires for a vessel to be filled or partially filled by an incoming liquid, and the incoming liquid flow is paused or stopped during treatment. Once the treatment has occurred the treated liquid is dispensed as the vessel is emptied, and the filling process using incoming liquid is repeated. The foam in a batch process is collected during the treatment phase, not during the filling stage.

The process of the disclosure can be performed on any liquid. The liquid can be water. The water can be wastewater. The waste in the wastewater can be PFAS. Thus, by wastewater it is meant any contaminated liquid comprising PFAS. The contaminated liquid can be a raw leachate. The contaminated liquid can be municipal water. The contaminated liquid can be surface water. The contaminated liquid can be groundwater. The liquid to be treated can be held in a holding tank before delivery to the first vessel.

In an embodiment, the incoming liquid is contaminated with PFAS and at least some of the PFAS is removed by the process. In an embodiment, substantially all of the PFAS is removed from the liquid by the process.

The amount of PFAS contaminant in the wastewater can be measured as the total PFAS concentration. Per- and polyfluoroalkyl substances (PFAS) are a group of man-made chemicals that includes perfluorooctanoic acid (PFOA), perfluorooctanesulfonic acid (conjugate base perfluorooctanesulfonate) (PFOS), Perfluorohexanesulfonate (PFHxS), Perfluorononanoic acid (PFNA), Perfluorodecanoic acid (PFDA), Perfluoroheptanoic acid (PFHpA), GenX, and many other chemicals. The main regulated PFAS compounds include: PFOA, PFHxS, PFOS, PFNA, PFDA, PFHpA.

There are thousands of PFAS compounds, most likely about 3000+. Some PFAS compounds are regulated, and in embodiments these are those that are intended to be subject to the methods of disclosure since the wastewater should be treated to meet regulations. Regulations change over time, so the present method can be directed to PFOA and PFOS which are regulated PFAS at the filing date. These are the most studied PFAS chemicals and have been voluntarily phased out by industry, though they are still persistent in the environment. GenX is a trade name for a technology that is used to make high performance fluoropolymers (e.g., some nonstick coatings) without the use of perfluorooctanoic acid (PFOA). hexafluoropropylene oxide-dimer acid (HFPO) dimer acid and its ammonium salt are the major chemicals associated with the GenX technology. The focus of the present process is on the removal of PFAS to reduce the likelihood of the regulated compounds requiring treatment in resultant waste e.g. sludge and to do so cost effectively.

Sum PFAS is the calculated PFAS concentration based on the constituents analysed. Of these PFOS and PFOA can be the target compounds as they are deemed higher risk and have been the focus of guideline values (regulations). However, of the 3000+compounds available labs typically can analyse for a select few. In one example, the lab can analyse for n=12/28/35 compounds. Some of the compounds are pre-cursors to others, meaning they may breakdown to the regulated compounds. A regulator may require the other PFAS to be treated to be removed as well, even though there is currently no published guidance. In some embodiments, the method reduced the sum PFAS. The sum PFAS can be the n12, 28 or 35 compounds. In all embodiments, the concentration of at least one PFAS compound is reduced to a lower concentration by the method.

In an embodiment, the first vessel is a foam fractionator. The second vessel can also be a foam fractionator. A foam fractionator, also known as a foam separator, is a device used in various industrial processes to remove organic compounds, proteins, and or other dissolved or suspended particles from a liquid (usually water). The primary purpose of a foam fractionator is to improve water quality by removing or at least reducing the concentration of pollutants and contaminants. While a foam fractionator can be used it should be understood that any vessel into which there can be a flow of liquid, and in which froth or foam can be created, is in scope.

Each vessel can be configured to receive incoming liquid for treatment. The vessel can have one or more inlets to receive the liquid to be treated. The first vessel can receive incoming liquid from a holding tank or supply reservoir of wastewater for treatment. The holding tank can be filled, for example, by pumping raw leachate through a mechanical control valve to control the volumetric flow to the supply reservoir. The level in the supply reservoir can be monitored by a submersible/pressure level transmitter.

The liquid to be treated can be pumped from the supply reservoir to the first vessel at a steady flow rate by a first feed pump. The liquid can be pumped into the top or near the top of the first vessel. Air can be injected into the bottom or near the bottom of the first vessel. The air can be injected, and bubbles formed via any means including fine bubble diffusers to generate air bubbles, venturi and or air-stones.

The second vessel can receive incoming liquid through an inlet. The liquid to be treated can be pumped to the second vessel at a steady flow rate. The liquid can be pumped into the top or near the top of the second vessel. Air can be injected as with the first vessel into the bottom or near the bottom of the second vessel.

In an embodiment there are one or more first vessels operating in parallel. The first foam collected from each first vessel can be treated separately or combined. The first treated liquid from each first vessel can be treated separately or combined. In an embodiment there are one or more second vessels operating in parallel. The second foam collected from each second vessel can be treated separately or combined. The second treated liquid from each second vessel can be treated separately or combined. If there is a third vessel the same description applies.

“Foam” and “froth” are both terms used to describe mixtures of gas (usually air) and liquid that result in a bubbly or frothy appearance. The term “foam” often implies a more stable and uniform structure, while “froth” might refer to a less uniform or more temporary bubbly arrangement. The present disclosure can be applied to either of foam or froth and the use of one term can be used interchangeably with the other unless the context makes clear otherwise.

Each vessel is associated with a blower, which injects air into the vessel for bubble formation. As the air bubbles travel upward through the vessel column, they will collect PFAS compounds. These bubbles create foam that accumulates at the top of the vessel column.

The predetermined foam production rate is difficult to estimate since it depends on a number of factors. Foam production is controlled by, for example, temperature, condition of the diffusers, gas flow rate amount of synthetic surfactant added and the natural surfactant level of the incoming contaminated water. Furthermore, foam production rate can be affected by operator intervention. A target foam production rate could be somewhere in the range of from less than about 1% and up to about 5%. However, typically, anything foaming above about 3% would be considered too much foam. Foaming is not always easy to control. Foam production requires experienced operators to make the right adjustments in real time.

The blower associated with the vessel creates a positive pressure in the vessel. Each vessel can comprise a hood. In the base of the hood is an upward facing cone, which causes the foam to rise through the cone and be trapped at the top of the vessel in the hood and which thereby assists in the build-up of pressure within the vessel. Each hood can have an opening therein which allows for the exit of foam. This exiting of the foam can be under pressure.

The pressure in the vessel can be used to assist in the removal of foam. The foam can pass out of the vessel under the influence of the positive pressure of the blower. In an embodiment, the hood from the vessel is removed and the foam is collected from the top of the cone without the hood (hoodless). The foam passes through a pipe connected to the top of the cone and is transferred under pressure into a foam collection tank. This is possible due to the positive pressure caused by the blower.

The foam can build up through e.g. a foam cone or hood and collapse and fall out via gravity through a manifold then into the foam tank. The foam tank can be any vessel suitable for collecting foam.

In an embodiment there is a first foam tank for collecting first foam from the first vessel. In an embodiment there is a separate second foam tank for collecting second foam from the second vessel. The foam from the first vessel can have a higher concentration of PFAS than the foam from the second vessel. In an embodiment, the foams from the first and second vessel can be combined for further treatment. However, in an alternative embodiment, foam from the first vessel is treated separately from second foam (or other foam or waste) since it comprises at least about 60, 70, 80, 90 or more % of the total PFAS from the original wastewater. In an embodiment, foam from the second vessel is recycled to the holding tank which is a reservoir of the original wastewater fed into the first vessel.

The first treated liquid is the liquid following treatment in the first vessel. The second treated liquid is the liquid following treatment in the second vessel. In embodiments, the effluent or treated liquid can be discharge via gravity from the respective vessel. A pump or air pressure can be used to assist in discharge from the vessel if required.

The treated liquid discharge manifold can be equipped with an actuated valve to control the flow rate of the treated liquid out of a given vessel to establish the height of liquid in the vessel. The feed pump variable speed drive (VSD) can control the feed flow rate to the vessel to match the rate of treated liquid discharge.

In embodiments, the first flotation step reduces the PFAS concentration (PFOA, PFHxS, PFOS, PFNA, PFDA, PFHpA and others) by at least 80, 90 or 95%. In an embodiment, the second flotation step reduces the total PFAS concentration (PFOA, PFHxS, PFOS, PFNA, PFDA, PFHpA and others) by about 90, 95% or more. If the PFAS concentration (PFOA, PFHxS, PFOS, PFNA, PFDA, PFHpA and others) in second treated liquid remains above the target discharge value, a third step of flotation can be applied to remove the total PFAS concentration to 98, 99 or 100%. However, this is difficult to estimate as a % because of the initial concentrations of PFAS in the Feed, and the Limit of Detection values in the analysis, impact this estimation.

In the first treated liquid, PFOA, PFHxS, PFOS, PFNA, PFDA and others can be removed at levels of >95% by treatment in the first vessel. PFHpA and others can be removed at >95% in the second vessel.

In an embodiment, the treated liquid from the second vessel or in the second break tank has a low enough PFAS concentration for the treated liquid to move to further processing for disposal or discharge. In another embodiment, in which the second liquid still has a reasonably high level of PFAS, a third stage of flotation may be required. The operator can make this assessment based on an analysis of the treated liquid in the second break tank using industry standard thresholds for contamination.

In an embodiment of the process, therefore, there is one or more third vessels configured to receive incoming second treated liquid from the second vessel or from the second break tank for treatment. The second treated liquid from the second vessel or second break tank can be pumped using a third vessel feed pump, optionally at a steady flow rate, into the top or near the top of the third vessel for further treatment. The one or more third vessels can generate a third treated liquid and a third foam.

The third treated liquid can be collected in a discharge tank. The third foam can be collected in a third foam tank; or in the second foam tank or in the first foam tank. In an embodiment, the third treated liquid in the discharge tank is low enough according to industry standards for PFAS that it can be discharged with little or no further treatment. If a treatment is required to remove PFAS or other contaminants from the third treated liquid, it can be selected from one of the additional processed outlined below. The third vessel can be equipped with a discharge manifold with an actuated valve to control the flow rate of the third treated liquid to establish the liquid height in the third vessel. The third vessel feed pump VSD will control the feed flow rate to match the rate of third treated liquid discharge.

The treatment of at least the foam from the first vessel which has the highest concentration of PFAS can comprise passing the foam to a fourth vessel. The fourth vessel can be a flotation cell. The fourth vessel differs from the first, second and third vessel flotation cells because it receives foam rather than liquid or treated liquid for flotation. The fourth vessel can be a concentrator or a hyper-concentrator of the foam intending to further dewater the PFAS contaminated foam for disposal. The foam can be mixed with a small amount of water prior to processing in the fourth vessel. The fourth vessel can be operated in batch mode. The foam from the first foam tank can be pumped by a fourth feed pump into the top or near the top of the fourth vessel until the foam level reaches an “operational level”. The blower can start at the same time as the fourth feed pump. A discharge control valve can remain fully closed during the fill phase. The blower continues to operate for a pre-set time. Foam from the fourth vessel can gravity feed to the foam discharge point for disposal. The foam can be discharged from the fourth vessel under the influence of positive pressure provided by the blower. Alternatively, the concentrated foam (fourth foam) from the fourth vessel can be sent for additional processes. The treated liquid dewatered from the foam in the fourth vessel can be sent to a holding tank or a break tank. In an embodiment, since the fourth treated liquid can still contain high levels of PFAS, the fourth treated liquid can be sent to the second foam tank. In an alternative embodiment, the fourth treated liquid can be sent to the reservoir of the original wastewater fed into the first vessel. The release of the fourth treated liquid to the second foam tank or to the reservoir can be after a pre-set time of operation of the fourth vessel. In an alternative embodiment, if the fourth treated liquid does not contain high levels of PFAS, it can be combined with the third treated liquid for disposal.

Background methods for the treatment of wastewater tend to be batch treatments of wastewater having reasonably consistent characteristics. For example, in the treatment of groundwater, the main variable in the composition of the groundwater is dilution by rainwater. A batch flotation process can be undertaken on groundwater, with adjustments made if the concentration of contaminants has been affected by dilution with rainwater. The pump providing incoming liquid into the fractionator can cause flow to be decreased or increased depending on the contamination concentration. Similarly, the pump or vortex device providing incoming air into the fractionator can cause flow to be decreased or increased depending on the contamination concentration.

In the alternative, embodiments of the present system lend itself to the treatment of a previously unknown kind of wastewater that is variable in contamination content and concentration. The operator may not know what to expect when the wastewater first flows into the first vessel. The present process allows for each vessel to be controlled independently to optimise the removal of waste.

It should be understood therefore that each vessel in the series has its own control systems. For example, each vessel can have its own blower, and each vessel has its own pump. The first vessel can have a first vessel feed pump and a first discharge pump. The second vessel can have a second vessel discharge pump and so on. In prior arrangements, a single feed pump was used for multiple vessels in series. These vessels were directly connected hydraulically and gravitationally fed to subsequent vessels without break tanks.

Each vessel requires a pump since the flow between vessels in the process is not gravity fed. The height of the liquid in a subsequent vessel may be set to higher than the height of the liquid in the immediately preceding vessel. Accordingly, a pump is required to achieve the required liquid height in the second vessel. In a continuous process, the concentration of waste to be removed from the incoming liquid decreases with each vessel in the sequence. The first vessel will remove a high percentage of the PFAS in the first flotation pass. The height of the liquid level in each subsequent vessel in the stagewise process may therefore be required to be higher to allow foam to dispense from the cone into the hood, since the amount of surfactant including PFAS in the infeed liquid becomes relatively lower through the sequence.

The operation parameters for each vessel that can be independently selected, controlled or adjusted include the hydraulic retention time (HRT), superficial gas velocity, the configuration of the vessel e.g. type of vessel (i.e. column), the height of the standpipe (which sets the water depth in the vessel), and the ratio of contaminated water treated per second to volume capacity of vessel, bubble size, pressure at the diffuser head, speed of the VSD which can set the height in the vessel, diffuser area coverage and blower specifications.

In an embodiment, PFAS contaminated waste is fed to the first fractionator (100% volume) to produce a reduced volume treated liquid stream or a water stream (99, 98, 97, 96 or 95%) and foam (1, 2, 3, 4, or 5%). In an embodiment, the optimisation of the parameters of the first process in the first vessel can focus on reducing the foam volume to less than about 5%. In some embodiments, the foam volume is reduced to less than about 2, 3, 4, or 5%. The treated liquid from the first vessel is fed to the second vessel.

The following parameters may be independently controlled:
Gas flowrate (superficial velocity)—a higher gas flow rate is expected to give greater enrichment and a drier foam that rises up the cone into the hood. In an embodiment, the air to liquid ratio in each vessel is greater than about 3, 5, 10, 15, 20, 25 or 30 m3/h:m3/h.
Liquid flowrate—a higher liquid flow rate introduces a greater amount of surfactant per unit time and this introduces greater foam production, requiring air adjustment to manage the foam. A lower liquid flow rate increases hydraulic retention time which is required to extract the maximum amount of PFAS from the bubbly liquid. In an embodiment, the air to liquid ratio in each vessel is greater than about 3, 5, 10, 15, 20, 25 or 30 m3/h:m3/h.
Liquid and Gas residence time—a minimum hydraulic retention time is needed to extract the maximum amount of PFAS from the bubbly liquid. In an embodiment, the hydraulic retention time can be less that 15, 20, 30, 40 or 60 minutes.
Bubble size—smaller bubbles will provide more surface area for adsorption but they do not dewater as easily. On the other hand, production of larger bubbles requires less energy and the bubbles dewater better, but PFAS capture may not be as good. The bubbles used in various embodiments of the present disclosure are not limited but are optionally fine bubbles having an average diameter less than about 3, 2, 1 or 0.5 mm.
Liquid Pool Depth—foam column height can be controlled by adjusting the liquid level in the column. It is essential to know the minimum/maximum depth of the liquid pool to achieve the optimum waste stream production rate. The vessels are sized to have a certain retention time at a certain flow rate. Changing liquid depth will have an effect on gas retention time within the liquid.
The adjustment of the liquid height in each vessel is possible by controlling the pump which controls the discharge of the liquid. The adjustment of the liquid height may also make use of an overflow pipe, discharge leg or standpipe, which is an open topped pipe in fluid communication with the vessel. The standpipe allows for liquid overflow and prevents or at least reduces syphoning. If the height of the liquid is too high in the vessel, some of the liquid can be drained through the standpipe at a set height. This height of liquid in the standpipe can be adjusted with a valve or pump. Conversely, if the incoming liquid is not flowing at a rate that is enough to lift the liquid level in the vessel, the standpipe valve or pump can be used to allow the liquid therein to pass into the vessel to establish a set height.
Foam column height—the minimum foam height to achieve maximum PFAS removal and a reasonable dewatering of foam.
Wastewater hydraulic residence time in column—HRT. In an embodiment, the wastewater is resident in the column (vessel) at least about 10, 20, 30, 40, 50 or 60 minutes. In various embodiments, the HRT is less than 60 minutes such as about 20 to 30 minutes. To establish that sufficient PFAS is being removed, tests can be performed on the discharge liquid and the residency time can be increased if more time removing PFAS is required.
Pressure control—In an embodiment, there is a pressure sensor mounted in each vessel. The pressure sensor can be calibrated to detect how much hydraulic head is present in the vessel (i.e. equivalent to water height). The valve controlling the inflow of liquid and or air flow into the vessel and or the outflow from the vessel can be adjusted manually or automatically so that the liquid height in the vessel is maintained at a set height, for example to establish a set point of foam production ln rate.

In an embodiment, the liquid treated in the first tank removes a high percentage of long chain PFAS. Long chain PFAS can be defined as PFAS having 6 or more carbon atoms in the chain. Without wishing to be bound by theory, it is thought that the removal of the long chain PFAS interferes with the removal of shorter chain PFAS. Accordingly, it is thought that the leachate from the first vessel will have some long chain PFAS removed, but short chain PFAS concentration will remain relatively unchanged. It is thought that about 80 to 99% of the long chain PFAS may be removed by the first vessel; while shorter chain PFAS removal may be about half or less than half of this percentage i.e. only about 40 or 50% (or less) of the shorter chain PFAS molecules are removed in the first vessel.

In an embodiment, a flocculant or polymer can be added to the second vessel to assist in the removal of short chain PFAS. Any known flocculant or polymer can be added. One such flocculant polymer is polydiallyldimethylammonium chloride (PolyDADMAC). PolyDADMAC has a positive charge that allows it to aggregate (flocculate) suspended solids and colloids into larger particles.

Thus, in another aspect of the disclosure there is a stagewise continuous flotation process comprising more than one stage of flotation for the removal of PFAS from wastewater,
a. a first vessel for flotation configured to receive incoming liquid for treatment, the first vessel generating a first treated liquid and a first foam comprising long chain PFAS; and
b. a second vessel for flotation configured to receive incoming first treated liquid from the first vessel for treatment, the second vessel generating a second treated liquid and a second foam,
wherein a flocculant is added to the second vessel to assist in the removal of short chain PFAS.

### BRIEF DESCRIPTION OF THE FIGURES

Embodiments of the disclosure will now be described with reference to the accompanying drawings which are not drawn to scale and which are exemplary only and in which:

FIG. 1 is a process flow diagram according to the background art.

FIG. 2 is a process flow diagram showing an embodiment of a process according to the present disclosure.

FIG. 3 is a process flow diagram similar to FIG. 2.

FIG. 4 is a process flow diagram showing the independent blowers for each vessel according to a further embodiment of the present disclosure.

FIG. 5 is a close up of the vessel of FIG. 4 showing an example of a standpipe.

### DETAILED DESCRIPTION

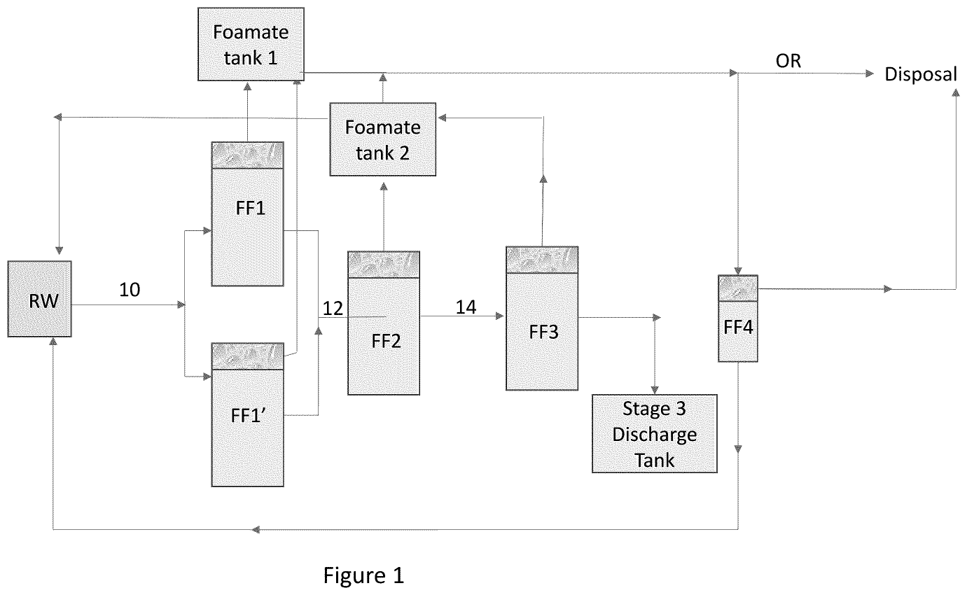

FIG. 1 is a process according to background art. Foam Fractionator Train 1 consists of four foam fractionators FF1, FF2, FF3 and FF4 each comprising a column. Air is injected into the bottom of each column. Air flow into the column is automatically adjusted by altering the blowers' Variable Speed Drive (VSD) speed to control the blowers' flow to a setpoint. A single blower can be used together with a manifold with a value input into each column. Each valve can be opened to allow air to blow into a respective vessel.

In this background art process, not in accordance with the present disclosure, only one feed pump is required for control of the flow rate through FF1, FF2 and FF3, which pre-sets the same flow rate for each fractionator. FF1, FF2 and FF3 are also supplied air by one blower.

The Raw Contaminated Water (RW) is transferred 10 via the Raw Water Pump from the Raw Water tank to Foam Fractionator #1 (FF1) at a pre-defined flow rate. A downstream Flow Meter monitors the instantaneous flow rate, cumulative flow and provides feedback to a flow controller or variable speed drive which adjusts the speed of the Raw Water Pump to ensure the target flow rate is maintained.

Raw Water is pumped into the top of FF1 while air bubbles are injected into the bottom via fine bubble diffusers. As the air bubbles travel upward through FF1, they collect PFAS compounds via adsorption at the air water interface. These bubbles accumulate at the top of the column to create an enriched foam. The foam collapses into a liquid called “foamate”, which builds up through the foam tube and launders via gravity through a manifold into Foamate Tank 1.

FF1 and FF2 are hydraulically connected by a decant leg 12 which maintains the fixed static height in FF1. The Treated Contaminated Water stream from FF1 will gravitate through a manifold to FF2 at the same flow rate as the feed to FF1 (minus foam production). Air added to the base of FF1 will impact the relative volume of Contaminated Water in FF1 and care must be taken not to cause a flow surge into FF2 as the air volume, in addition to the raw water volume, can exceed the required column height. This surge can cause an overflow from the FF1 syphon breaker, which is an open standpipe above the decant leg 12.

The Contaminated Water flow into FF2 must be set at the same rate as for FF1 to ensure the actual Contaminated Water volume in FF1 and FF2 are the same, avoiding flow surges and spillage from the FF1 decant leg. Hence the hydraulic retention times in FF1 and FF2 are the same. There can be more air injected into FF2 relative to FF1 because the liquid is likely to foam less.

The foam from FF2 launders into the FF2 foamate collection tank. FF2 and FF3 are similarly hydraulically connected as FF1 and FF2 by a decant leg 14 which maintains the fixed static height in FF2. The Contaminated Water from FF2 will therefore gravitate through a manifold to FF3 at the same rate as the Contaminated Water to FF2 (minus FF1 and FF2 foam production). Air added to the base of FF2 will impact the relative volume of leachate in FF2 and care must be taken not to cause a flow surge into FF3 as the air volume, in addition to the raw leachate volume, exceeds the fixed height. This surge can cause an overflow from the FF2 syphon breaker, which is an open standpipe above the decant leg 14.

The Contaminated Water flow into FF3 must be set at the same rate as for FF2 to ensure the actual Contaminated Water volume in FF2 and FF2 are the same, avoiding flow surges and spillage from the FF2 decant leg. Hence the hydraulic retention times in FF2 and FF3 are the same.

Only one feed pump is utilised for FF1, FF2 and FF3 because the decant flow from FF1 reports to FF2 and decant from FF2 reports to FF3. All hydraulic set points for FF1 are required to be the same as for FF2 and FF3 because they are hydraulically linked by a decant transfer pipe. Modifications to operating parameters such as the aeration rate, Contaminated Water flow rate or hydraulic retention time in each respective fractionator FF1, FF2, FF3 in response to a requirement for an individual fractionator, for example, different hydraulic static heights or flow rates are not possible because all are impacted by the settings of each adjacent fractionator.

For example, if a greater hydraulic retention time in FF2 was required to allow for higher removal or some contaminants, FF2 could not operate at a higher level than FF1. In another example, if FF2 requires an increase to create a required foam formation rate, the increase in air will combine with the water volume to increase the overall volume in FF2 and cause a surge of liquid into FF3, which could exit the top of the standpipe on the FF2 antisyphon leg.

FF3 treated water is pumped or gravity fed to a disposal point.

Foamate from FF1 and/or FF2 and/or FF3 can be disposed of directly or pumped to FF4 for hyper-concentration. The foamate is pumped into FF4 using the FF4 feed pump until the required static height is reached. Air is injected into the bottom of FF4 and air flow is automatically adjusted by altering the FF4 blower's VSD speed to control the blowers' flow to a setpoint. FF4 is run in batch mode for a pre-set time, or in continuous mode for a fixed period of time. FF4 foamate is sent for disposal or additional treatment such as destruction or thermal evaporation or fixation onto a solid media for additional volume reduction. After the preset time has elapsed, FF4 Treated Water will return to the Raw Contaminated Water tank or if sufficiently depleted of contaminants, be combined with FF3 TL for disposal.

If FF2 and FF3 foamate is not sent to FF4 for hyperconcentration, it will be pumped from Foamate Tank 2 back to the Raw Contaminated Water tank.

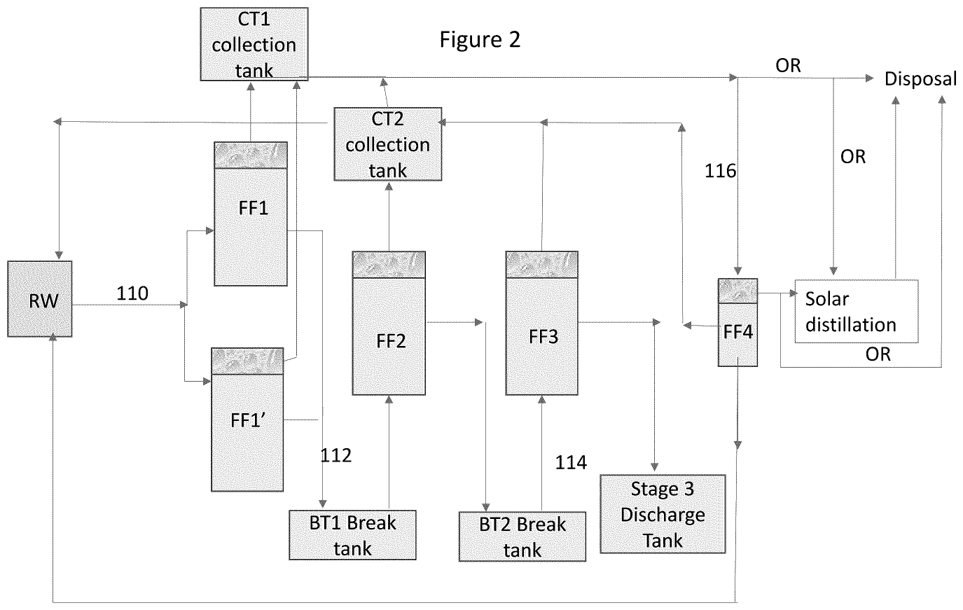

FIG. 2 shows an embodiment of a process according to the disclosure. In FIG. 2

There is shown an above ground method of dewatering contaminated waste such as raw leachate RL comprising PFAS. It also shows an above ground method for generating a highly PFAS concentrated waste stream which ultimately ends up at “disposal”. The raw wastewater which can be leachate is fed to the first vessel. The wastewater can be pumped to the first vessel at a rate of e.g. about 25 gal/min (8 kL/h).

In a first vessel FF1, the contaminated waste comprising PFAS is actively aerated by injection of air into the vessel. In an embodiment the first vessel is a foam fractionator FF1 and the active aeration is the formation of bubbles in the fractionator. The PFAS contaminated waste is passed through the first foam fractionator FF1 from an input and out via an output as depicted schematically by arrows. There can be more than one first foam fractionator operated in parallel FF1 and FF1′. The process at the first stage produces a first foam which is sent to the CT1 foam collection tank and which comprises a concentration of PFAS. The process also results in a first treated liquid which is sent to the BT1 break tank.

The first treated liquid in the BT1 break tank is subject to a second process comprising actively aerating the waste stream in a second vessel FF2. In an embodiment the second vessel FF2 is also a foam fractionator FF2. This produces a second foam which is sent to the CT2 collection tank. The second vessel FF2 also produces a second treated liquid which is send to the BT2 break tank.

The second treated liquid can be discharged, or it can be sent to a third vessel FF3. The third vessel FF3 can be a foam fractionator FF3. The third foam produced at the third vessel FF3 can also be collected in the CT2 collection tank. The third treated liquid can be sent to the Stage 3 discharge tank. The discharge of the treated liquid can be undertaken under usual conditions as is known in the industry.

The foam from the CT1 collection tank, optionally combined with the foam from the CT2 collection tank can be sent to a fourth vessel FF4. The foam can be treated to further dewater it and then it can be sent to solar distillation (solar drying). The waste foam from vessel CT1 can be circulated through the solar drying multiple times until a salt concentration is maximised without compromising flow. The number of recirculation passes within the distillation unit depends on solar radiation rates specific to the location, flow volume relative to scale of solar drying and contaminant levels in waste stream from vessel. The treated foam from the solar drying can be passed on to a further drying bed prior to disposal or just disposal. The cost effectiveness of this process depends critically on the volume of the contaminated waste stream that has to be shipped to a treatment plant for safe disposal or destruction.

Approaches to the destruction of PFAS include high temperature incineration, plasma arc pyrolysis, super critical water oxidation, electro-oxidation, chemical oxidation and cement kiln combustion. An alternative to destruction is disposal of concentrated PFAS liquid or sludge in non-biodegradable packaging at landfill. In most cases there is an economic imperative to reduce the volume of the treated waste stream containing PFAS since (a) transport of this waste stream can be expensive and proportional to the total volume of waste to be transported, and or (b) treatment costs are typically proportional to the total volume of waste to be treated.

The process of the disclosure is now described with reference to the components of FIG. 2. As shown and discussed above, Foam Fractionator Train 1 consists of four foam fractionators FF1, FF2, FF3 and FF4 each comprising a column.

Air is injected into the bottom of each fractionator column. Air flow rate is automatically adjusted by altering the blowers' VSD speed to measure the blowers' flow to a controlled setpoint. FF1, FF2, FF3 and FF4 have individually designated Feed pumps and air supply blowers.

The Raw Contaminated Water (RW) is transferred 110 via the Raw Contaminated Water Pump from the Raw Contaminated Water tank to Foam Fractionator #1 (FF1) at a defined flow rate. A downstream Flow Meter monitors the instantaneous flow rate, cumulative flow and provides feedback to a flow controller which will adjust the speed of the Raw Contaminated Water Pump to ensure a target flow rate is maintained.

Each of FF1, FF2 and FF3 have individual designated Feed pumps controlled by a VSD and individual air supply pumps controlled by a VSD.

Raw Contaminated Water is pumped into the top of FF1 whilst air bubbles are injected into the bottom via fine bubble diffusers. As the air bubbles travel upward through FF1, they collect PFAS compounds via adsorption at the air water interface. These bubbles accumulate at the top of the column to create an enriched foam. The foam collapses into a liquid called “foamate”, which builds up through the foam tube and launders via gravity through a manifold into Collection Tank CT1.

FF1 and FF2 are hydraulically separated from one another. FF2 is separated from the upstream fractionator by the use of a break tank 1. Treated liquid from FF1 flows 112 to the break tank 1 The static height level of FF1 is set using a valve on the discharge leg of the FF1 fractionator. The Feed flow rate 110 into FF1 is controlled by the Feed pump VSD to balance this flow rate. The air flow of FF1 is adjusted to control the air:liquid ratio setting in FF1.

The break tank 1 allows for vitally important parameters in FF1 to be modified during a run such as the FF1 static height, HRT, the air flow rate, and air:liquid ratio, to be independently adjusted to optimise the operation of FF1 to achieve the required outputs, such as foam production rate, foam dryness and Treated Water PFAS concentration. The break tank 1 absorbs fluctuations in flow from FF 1 to FF2 while these parameters are being altered. For example an increase or decrease in air flow rate, or an increase or decrease in Feed flow rate will impact the flow of Treated Water from FF1 to FF2, but the break tank enables the pre-set parameters of FF2 to remain unchanged during the alteration of FF1 settings. The important FF2 parameters can then be individually adjusted independently if required without influence from the operation of FF1.

FF2 and FF3 are similarly separated from one another. The FF3 fractionator is hydraulically separated from the upstream fractionator by the use of a further break tank 2. The static height level of FF2 is set using a valve on the discharge leg of the fractionator. The Feed flow rate 114 into FF2 is controlled by the FF2 pump VSD to balance this flow rate. The air flow of FF2 and FF3 is adjusted to control the air:liquid ratio setting.

The further break tank 2 allows for vitally important parameters in FF2 to be modified during a run such as static height, HRT, the air flow rate, and air:liquid ratio, to be independently adjusted to optimise the operation of FF2 to achieve the required outputs, such as foam production rate, foam dryness and Treated Water PFAS concentration. The break tank 2 absorbs fluctuations in flow from FF2 to FF3 while these parameters are altered. For example an increase or decrease in air flow rate, or an increase or decrease in Feed flow rate will impact the flow of Treated Water from FF2 to FF3 but the break tank enables the pre-set parameters for FF3 to remain unchanged during the alteration of FF2 settings. The important FF3 parameters can then be individually adjusted if required independently and without influence from the operation of FF2.

The foam from FF2 launders into collection tank 2 via gravity. FF3 Treated Water is discharged via gravity or pump to the sewer or other receptor. The foam from FF3 launders into the FF2 foamate collection tank 2.

Foamate from FF1 and/or FF2 and/or FF3 can be disposed of directly by pumping to FF4 for hyper-concentration. The foamate is pumped into FF4 using the FF4 feed pump until the required static height is reached. Air is injected into the bottom of FF4 and air flow is automatically adjusted by altering the FF4 blower's VSD speed to control the blowers' flow to a setpoint. FF4 is run in batch mode or continuous mode for a pre-set time. FF4 foamate is sent for disposal or additional treatment such as destruction or thermal evaporation or fixation for additional volume reduction. After the preset time has elapsed, FF4 Treated Water will return to the Raw leachate tank or if contaminants have been sufficiently depleted, combined with the FF3 TL for disposal.

If FF2 and FF3 foamate is not sent to FF4 for hyperconcentration, it will be pumped from Foamate Tank 2 back to the Raw Contaminated Water tank.

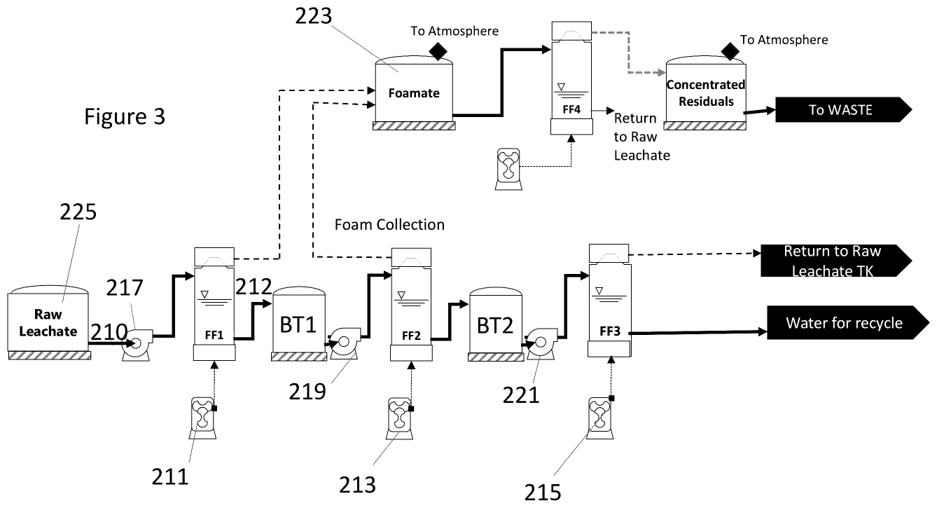

FIG. 3 shows an embodiment of a process according to the disclosure. In FIG. 3 there is the same process flow as in FIG. 2, but each vessel is shown with an independent pump 217, 219 and pump 221. There are also three blowers 211, 213, 215. Air is injected into the bottom of each fractionator column FF1 to FF3. Air flow rate is automatically adjusted by altering the blowers' VSD speed to measure the blowers' flow to a controlled setpoint.

In a first vessel FF1, the contaminated waste comprising PFAS is actively aerated by injection of air into the vessel by blower 211. The process at the first stage produces a first foam which is sent to the foam collection tank 223. The process also results in a first treated liquid which is sent to the BT1 break tank.

The first treated liquid in the BT1 break tank is subject to a second process comprising actively aerating the waste stream in a second vessel FF2. In an embodiment the second vessel FF2 is also a foam fractionator FF2. This produces a second foam which is sent to the collection tank 223. The second vessel FF2 also produces a second treated liquid which is send to the BT2 break tank.

The second treated liquid can be discharged, or it can be sent to a third vessel FF3. The third foam produced at the third vessel FF3 can be recycled to the raw leachate tank 225. The third treated liquid can be suitable for recycling. The discharge of the third treated liquid can be undertaken under usual conditions as is known in the industry. The foam in tank 223 can be sent to a fourth vessel FF4 (which can be referred to as Foam Concentrator 1 (FC1)).

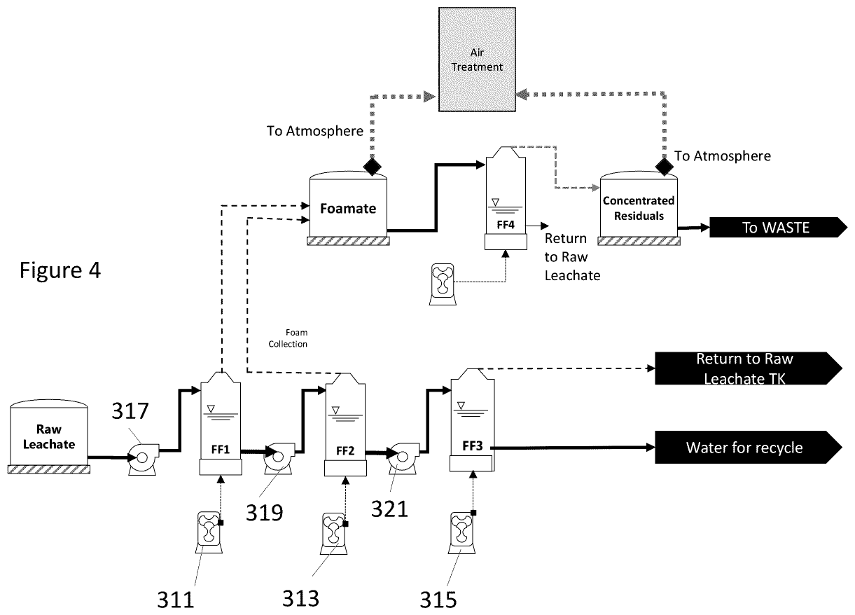

FIG. 4 shows an embodiment of a process according to the disclosure in which there are no break tanks. Furthermore, each of the vessels has the option to include a hood or to be installed without a hood to allow for foam removal by positive pressure. Each vessel is shown with an independent pump first feed pump 317, first discharge pump 319 and second discharge pump 321. There are blowers 311, 313, 315. Air is injected into the bottom of each fractionator column FF1 to FF3. Air flow rate is automatically adjusted by altering the blowers' VSD speed to adjust the blowers' flow to a controlled setpoint.

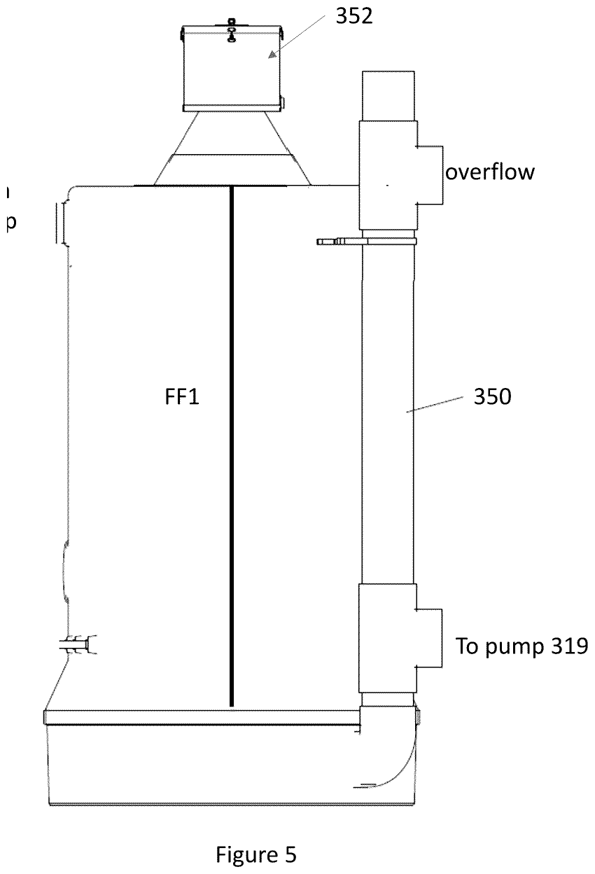

All vessels are hydraulically independent. The treated liquid exits FF1 through an anti-syphoning standpipe (shown in FIG. 5) that is connected to first discharge pump (319). This pump will pump water to the port at the top of FF2. The treated liquid exits FF2 through an anti-syphoning standpipe, that is connected to second discharge pump (321) that will pump water to the port at the top of FF3. The first feed pump (317) that feeds FF1 will control the overall operating flow rate of the entire system. Pumps 319 and 321 will control the operating height of the water in their associated fractionator.

The open topped standpipe 350 transferring treated liquid from FF1 to FF2 is fitted with a pump 319 that is operated using a VSD. It should be understood that each of the fractionators FF herein, optionally comprising hood 352 as shown in FIG. 5, can be associated with a standpipe 350 but only one FF is shown in the Figures.

FF1 is fitted with a pressure sensor at its base, and this sensor is used to measure the pressure (height) of fluid in the vessel. The pressure sensor can be calibrated to detect how much hydraulic head is present in the vessel (i.e. equivalent to water height). If the liquid level in FF1 requires altering, the VSD controlling pump 319 will adjust to either lower or increase the water level in FF1 as required. This is accomplished because pump 317 will provide a fixed flow rate into the FF1. Pump 319 will increase its flow to reduce the water level and decrease its flow to increase the water level.

The standpipe transferring treated liquid from FF2 to FF3 is fitted with a feed pump 321 that is operated using a VSD. FF2 is fitted with a pressure sensor at its base, and this sensor is used to measure the pressure (height) of fluid in the vessel. If the liquid level in FF2 requires altering, the VSD controlling pump 321 will adjust to either lower or increase the water level in FF2 as required. Pump 321 will increase its flow to reduce the water level and decrease its flow to increase the water level.

FF3 is fitted with a pressure sensor at the base of FF3 and is used to measure the pressure (height) of fluid in the vessel. The water level in FF3 is controlled by an automated valve on the standpipe of FF3. This proportionally controlled valve will adjust to control the rate of flow from FF3 to allow for the adjustment of fluid height in FF3.

In various embodiments, the process does not make use of activities that are energy intensive. The low energy process has a low overall energy consumption (kWh). The energy requirement in kWh/m³ of treated Contaminated Water is linked purely to the PFAS removal stages.

In embodiments, even after optimisation of the parameters in the first and second (and optionally third) vessels, and even if it is passed through the fourth vessel, the resultant foam will likely benefit in further volume reduction to minimise the cost of destruction and/or disposal. Volume reduction of the foam is particularly desirable when the foam has to be stored or ultimately transported off-site for disposal or incineration or other non-thermal destruction process. Volume reduction is by passing the PFAS contaminated foam through a further process, to produce a more concentrated waste stream that has a PFAS concentration that is higher than the previous concentrations.

In embodiments, possible viable options to further concentrate or treat the foam comprise:

### (1) Drying—Evaporation or Thermal Processes

Drying of the foam using pan evaporation and solar concentration offers a potentially simple option to dry the foam, but also introduces issues associated with open ponds and their inundation during rainfall events. To enhance the evaporation of the foam, solar drying can be accomplished in covered drying beds or greenhouses. The solar drying system (enclosed greenhouse) can comprise of a rectangular base structure and translucent chambers, circulation fans, ventilation fans, and optionally (if needed) a mobile electro-mechanical device that turns the solids periodically. The primary advantage of the solar drying system is that solar radiation is the main source of drying energy, reducing the need for high energy active drying processes, and the footprint is likely much smaller than an open pond. In some embodiments a first drying method could be used to concentrate larger volumes of foam, and then a small solar drying (if needed) can be used for reduction to salt only, for removal and destruction.

In some embodiments a first drying method could be used to concentrate larger volumes of foam, and then a small solar drying (if needed) can be used for reduction to salt only, for removal and destruction.

Foam volume reduction may also be accomplished using active thermal drying. Thermal drying involves the application of heat to evaporate water and further reduce the moisture content of the foam. Thermal drying is a process that has a small footprint, however it has relatively high capital and energy cost and due to its complexity requires highly trained operating staff.

The concentrated foamate can be pumped through a series of solar powered evaporative systems called Carocells. Solar energy heats the foamate, where it vaporises, then condenses on the inside of the panel enclosure. Droplets of distilled water run down into a water outlet at the bottom of the unit. As a result the foamate concentrates to a level that allows it to be collected at a much reduced volume. This process can be repeated multiple times to achieve the maximum volume reduction.

### (2) Activated Carbon

Depending on the foam properties, it may be possible to use Granular Activated Carbon (GAC) or powdered activated carbon (PAC) to absorb PFAS from the foam. The process can be evaluated by undertaking isotherm testing, to assess PFAS capacity on the GAC or PAC. The use of GAC or PAC will generate spent GAC or PAC requiring disposal, but offers a pathway to remove PFAS from foam.

The foam potentially could be pumped through a GAC column to adsorb contaminants. Adsorption is both the physical and chemical process of accumulating a substance at the interface between liquid and solids phases. Activated carbon is an effective adsorbent because it is a highly porous material and provides a large surface area to which contaminants may adsorb. PFAS and other compounds will be adsorbed into the GAC. The GAC is usually disposed of once expended.

The foam potentially could be pumped into a stirred vessel containing PAC to adsorb contaminants. Adsorption is both the physical and chemical process of accumulating a substance at the interface between liquid and solids phases. Activated carbon is an effective adsorbent because it is a highly porous material and provides a large surface area to which contaminants may adsorb. PFAS and other compounds will be adsorbed into the PAC. The PAC is usually filtered from the solution and disposed of once expended.

### (3) Ion Exchange

Ion exchange has also been used for the removal of PFAS's from groundwater. However, depending on the foam characteristics, it may be a practical option. Ion exchange is an exchange of ions between two electrolytes or between an electrolyte solution and a complex molecule. In most cases the term is used to denote the processes of purification, separation, and decontamination of aqueous and other ion-containing solutions with solid polymeric or mineral media. Ion exchange is as the name suggest the exchange of one ion for another. Remove one ion of contaminant and release an ion of that we can tolerate or deal with at a later stage. It may be possible to use this technology to further reduce the PFAS volume. The Ion Exchange resin requires regeneration or disposal when expended. This will require additional chemicals (Acids/Bases) which will require disposal.

### (4) Nano-Filtration and/or Reverse Osmosis

Nano-filtration (NF) and/or reverse osmosis (RO) have been demonstrated as methods of separating PFAS's from groundwater and leachate. It may not be suitable for foam due to high TDS, TSS and contaminants that can foul or block a membrane. However, again depending on the foam characteristics, it may be a practical option. NF or RO provides a membrane which the PFAS components cannot pass through. This technology can be used to reduce the foam volume prior to optional solar distillation and evaporation.

### (5) Wetlands

Wetlands such as reed bed (RB) vertical or horizontal systems are designed to passively reduce volume by maximising evapotranspiration and filtration/absorption of some contaminants. The process involves utilising gravity, sunlight and transpiration to reduce the waste stream volume. It is thought that reed bed concertation will work very well if the soil and filter and plants take up the PFAS, and no PFAS drains out of the reed beds in the filtrate. However, all the biosolids produced would be PFAS contaminated and need destruction or disposal.

The choice of which further processing to use, will depend on the nature of the contaminated waste being handled. To use activated carbon or ion exchange, which are absorption processes, the wastewater needs to be very clean already, or (carbon especially) absorbs many of the co-contaminants. NF and RO also need relatively clean water free from solids. Solids removal and antiscalants are often required. Clean In Place is also frequently required.

It is to be understood that, if any prior art publication is referred to herein, such reference does not constitute an admission that the publication forms a part of the common general knowledge in the art, in Australia or any other country.

In the claims which follow and in the preceding description of the disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

1. A continuous stagewise flotation process comprising more than one stage of flotation with independent hydraulic control, the process comprising:
a. a first vessel for flotation configured to receive incoming liquid for treatment, the first vessel generating a first treated liquid and a first foam;
wherein the first vessel is associated with a first feed pump for hydraulically controlling the incoming liquid into the first vessel; and a first discharge pump for hydraulically controlling the discharge of first treated liquid from the first vessel; and the first foam is collected in a foam tank;
b. a second vessel for flotation configured to receive incoming first treated liquid from the first discharge pump, the second vessel generating a second treated liquid and a second foam,
wherein the second vessel is associated with a second discharge pump for hydraulically controlling the discharge of second treated liquid from the second vessel; and the second foam is collected in the foam tank.

2. The process of claim 1, wherein there is further
a third vessel for flotation configured to receive incoming second treated liquid from the second discharge pump, the third vessel generating a third treated liquid and a third foam,
wherein the third vessel is associated with a discharge valve for controlling the discharge of third treated liquid from the third vessel; and
the third foam is collected in the foam tank.

3. The process of claim 1,
wherein the first treated liquid is collected in a first break tank; and the one or more second vessels are configured to receive incoming first treated liquid from the first break tank for treatment; and
the second treated liquid is collected in a second break tank; and
if present, the third treated liquid is collected in a third break tank.

4. The process of claim 1, wherein there is more than one first vessel operated in parallel.

5. The process of claim 2, wherein the first foam is collected in a first foam tank and the second foam is collected in a second foam tank.

6. The process of claim 5, wherein the contents of the second foam tank are mixed with the contents of the first foam tank.

7. The process of claims 5, wherein the contents of the second foam tank are mixed with the incoming liquid for treatment into the first vessel.

8. The process of claim 5, wherein the third foam is collected in the second foam tank.

9. The process of claim 5, wherein the contents of the first foam tank optionally together with the contents of the second foam tank are sent for disposal with no further treatment.

10. The process of claim 5, wherein the contents of the first foam tank optionally together with the contents of the second foam tank are sent for further treatment such as solar distillation.

11. The process of claim 1, wherein each vessel is a foam fractionator comprising a hood.

12. The process of claim 1, wherein each vessel is a hoodless foam fractionator.

13. The process of claim 1, wherein each pump is variable speed drive pump.

14. The process of claim 1, further comprising
a fourth foam vessel, preferably a foam fractionator, configured to receive at least incoming first foam from the first foam tank for treatment, the fourth foam vessel generating a fourth treated liquid and a fourth foam.

15. The process of claim 14, wherein the fourth treated liquid is sent to the second foam tank.

16. A continuous stagewise flotation process comprising more than one stage of flotation for the removal of PFAS from wastewater,
one or more first vessels for flotation configured to receive incoming liquid for treatment, the first vessel generating a first treated liquid and a first foam comprising long chain PFAS; and
one or more second vessels for flotation configured to receive incoming first treated liquid from the first vessel for treatment, the second vessel generating a second treated liquid and a second foam,
wherein a flocculant is added to the second vessel to assist in the removal of short chain PFAS.

17. The process of claim 16, wherein the flocculant is polydiallyldimethylammonium chloride (PolyDADMAC).

18. The process of claim 16, wherein each vessel is associated with a pump to permit independent control over the outgoing liquid flow.

19. The process of claim 16, wherein there is a break tank between each first and each second vessel.

20. Liquid when treated by the process of claim 1.
